(19) United States
(12) Patent Application Publication
(10) Pub. No.: US 2009/0188470 A1
(43) Pub. Date: Jul. 30, 2009

(54) Hold-down device

(76) Inventor: Ingo Rettig, Schwieberdingen (DE)

Correspondence Address: KENYON & KENYON LLP, ONE BROADWAY, NEW YORK, NY, 10004, US

(21) Appl. No.: 11/988,910

(22) PCT Filed: Jun. 2, 2006
(86) PCT No.: PCT/EP2006/062856

§ 371 Date: Mar. 4, 2009

(30) Foreign Application Priority Data
Jul. 15, 2005 (DE) 10 2005 033 139.4

(51) Int. Cl. F02M 61/14; B23P 19/04

(52) U.S. Cl. 123/470; 29/216

(57) ABSTRACT

A hold-down device for elastically fastening multiple fuel injectors, which are held down in a cylinder head of the internal combustion engine via spring elements for directly injecting fuel into the combustion chamber of an internal combustion engine, has a rail-shaped design having recesses for receiving the multiple fuel injectors.

### FIELD OF THE INVENTION

The present invention is directed to a hold-down device for attaching one or more fuel injectors in a cylinder head of an internal combustion engine.

### BACKGROUND INFORMATION

Hold-down systems of this type are usually designed individually for each fuel injector of an internal combustion engine. The fuel injector is either connected directly to the fuel distributor line and pressed into the cylinder head by the fuel distributor line via a hold-down element or retained in the cylinder head by a clamping claw, which is supported on a shoulder of the fuel injector.

For example, a fastening device for reciprocally attaching a fuel injector in a cylinder head of an internal combustion engine and for fixing it to a fuel distributor line is disclosed in German Published Patent Application No. 101 33 264. The fastening device is implemented in the form of a spring clamp, which is elastically clamped between a shoulder of the fuel injector and a shoulder of the fuel distributor line.

Furthermore, a fastening device for fastening a fuel injector for directly injecting fuel into the combustion chamber of an internal combustion engine in a cylinder head of the internal combustion engine is described in German Published Patent Application No. 101 12 665. The fastening device includes a hold-down device which is slipped onto the fuel injector, the hold-down device being designed as a flat component and being supported on a sleeve which encloses the fuel injector, which presses against a preferably metallic collar of the fuel injector.

The known fastening devices have the disadvantage of having high manufacturing and mounting costs due to many individual components. In addition, it is disadvantageous that due to the increasing fuel and combustion chamber pressures, even small offsets of the fuel injectors due to transverse forces of the fuel distributor line connected to the fuel injector valves, for example, may suffice to cause a leak between the fuel injector and cylinder head and/or leaks in the area of the O-ring seal between the fuel injector and the fuel distributor line, which has undesired effects on fuel consumption, exhaust gas emission, and the running behavior of the internal combustion engine.

### SUMMARY

The hold-down device according to example embodiments of the present invention for a fuel injector has the advantage in relation thereto that multiple fuel injectors, for example, all fuel injectors of a cylinder bank, may be held down simply and securely by a common hold-down device so that a single, complex fastening of the fuel injectors to the cylinder head is dispensed with.

The hold-down device ensures both transmission of the hold-down force to the fuel injector and flexible fixing which compensates for tolerances and offsets.

It is advantageous in particular that a formfitting connection between the hold-down device and the fuel injectors is made possible by the suitable design of recesses.

The hold-down device is advantageously provided with a U-shaped profile, which is easily manufacturable by bending and stamping, for example.

Furthermore, it is advantageous if flexible spring elements are provided, which are either formed in one piece with the hold-down device or are situated between the hold-down device and the fuel injectors and thus allow tolerance compensation and simple simultaneous manufacturing and mounting.

Exemplary embodiments of the present invention are illustrated in simplified form in the drawings and explained in greater detail in the following description.

### BRIEF DESCRIPTION OF THE DRAWINGS

FIGS. 1A-B show two schematic illustrations of conventional hold-down devices,

FIG. 2 shows a schematic perspective view of an exemplary embodiment of a hold-down device for fuel injectors implemented according to the present invention, and

FIG. 3 shows a schematic perspective view of an exemplary embodiment of a hold-down device for fuel injectors implemented according to the present invention.

### DETAILED DESCRIPTION

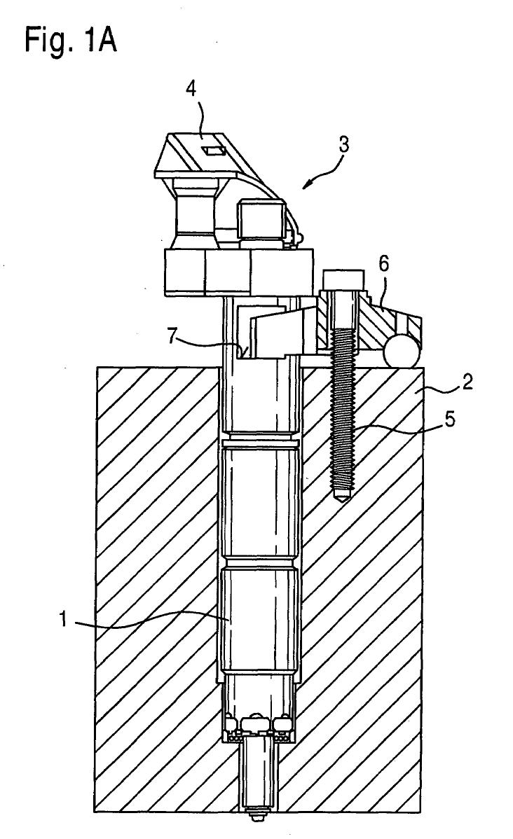

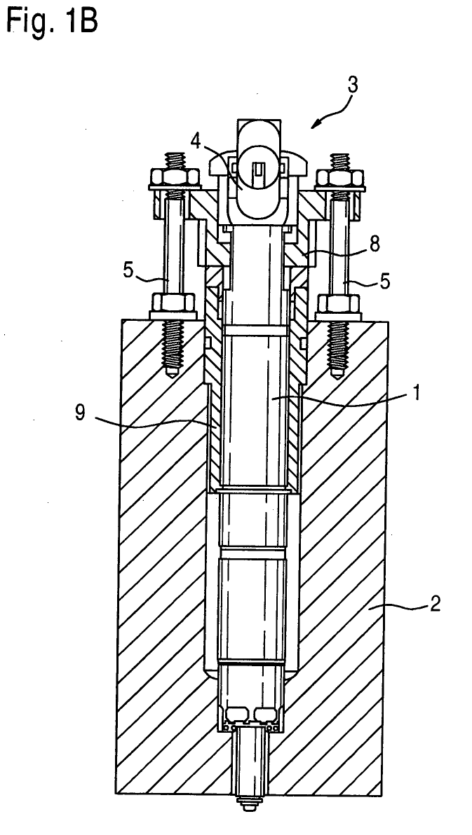

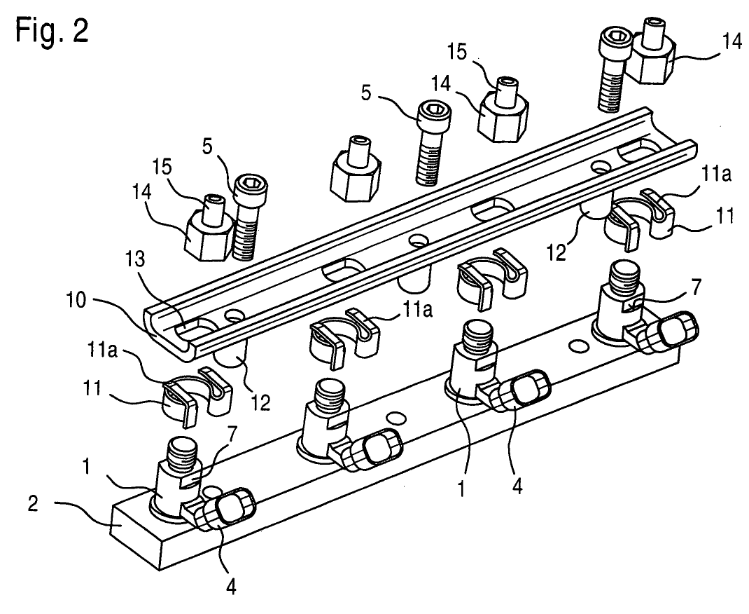

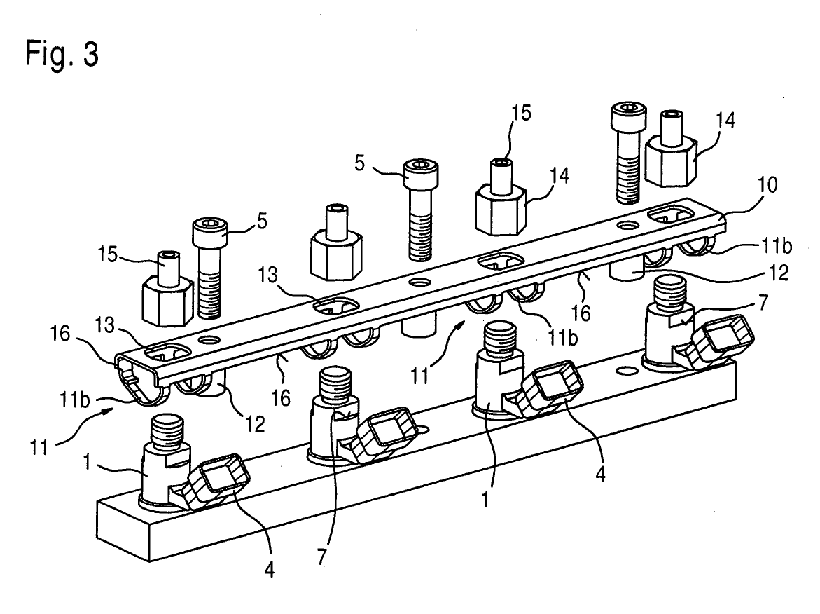

Before two exemplary embodiments of hold-down devices implemented according to the present invention are explained on the basis of FIGS. 2 and 3 the typical hold-down device will be explained briefly on the basis of FIGS. 1A and 1B to provide better understanding of the measures hereof.

FIGS. 1A and 1B show schematic partial sections through exemplary embodiments of hold-down devices for one conventional fuel injector each.

A fuel injector 1 is designed in the form of a direct-injection fuel injector 1, which is installed in a cylinder head 2 for directly injecting fuel into a combustion chamber of an internal combustion engine (not shown further), which is in particular mixture-compressing and externally-ignited or compression-ignited. Fuel injector 1 has a screw connection to a fuel line (not shown further) on a supply-side end 3. Fuel injector 1 has an electrical terminal 4 for the electrical contact for actuating fuel injector 1.

In direct-injection fuel injectors 1, a separate fuel line is mounted per fuel injector 1. Fuel injectors 1 are each secured individually in cylinder head 2. This may be, as shown in FIG. 1A, for example, a clamping screw 5 having a hold-down claw 6, which presses against a shoulder 7 of fuel injector 1 and presses fuel injector 1 into cylinder head 2 by clamping screw 5 with limited absorption of transverse forces.

A similar option is fixing by a flange 8, which is supported on a compression sleeve 9 mounted in cylinder head 2 and is also secured using clamping screws 5. Only limited absorption of transverse forces is possible here.

These conventional hold-down arrangements have the disadvantage that transverse forces on fuel injectors 1 may only be absorbed inadequately by cylinder head 2, which may result in damage to fuel injectors 1 and in leaks in the connection between fuel injector 1 and the fuel line. The latter in particular is to be dealt with in consideration of rising fuel and combustion chamber pressures and ever stricter guidelines in regard to the exhaust gas and fuel emissions.

In addition, disadvantageous installation situations result due to the connection of fuel injectors 1 in receptacles of a fuel distributor line supplying fuel to all fuel injectors 1, which typically has a tubular design and extends along cylinder head 2, because the available space in the engine compartment of many motor vehicles is becoming increasingly small. However, if the fuel distributor line may not be situated directly above fuel injectors 1 because of the installation situation, leakage problems result due to inadequate hold-down forces. A replacement is thus sought for the rail-shaped fuel distributor line situated directly above fuel injectors 1 having receptacle cups for fuel injectors 1 in favor of individual fuel lines, which discharge into a fuel distributor line, which may be situated beyond the typical mounting position.

Therefore, it is provided according to example embodiments of the present invention that multiple fuel injectors 1, for example, all fuel injectors 1 of a cylinder bank, be fixed by a shared hold-down device 10 having spring elements 11. Spring elements 11 are used to compensate for axial and radial tolerances as a result of manufacturing and installation. Example embodiments of the present invention reduce and simplify the required components, their manufacturing and mounting expenditure including the manufacturing costs, and the processing of the connection geometries on the internal combustion engine.

An exemplary embodiment of a hold-down device 10 implemented according to the present invention is shown in FIG. 2 in a schematic perspective illustration.

Hold-down device 10 has a simple basic shape which, for example, may have a rail-shaped design having a U-shaped cross section, the U-shape opening facing away from cylinder head 2. Such a shape is manufacturable easily by stamping and bending, for example, and may be adapted as desired to the contours of cylinder head 2, notwithstanding the linear form shown.

Hold-down device 10 is mounted on cylinder head 2 via clamping screws 5, by which the position of fuel injectors 1 relative to one another and to cylinder head 2 may be defined. There are at least two clamping screws 5, because hold-down device 10 has an oblong shape. Three clamping screws 5 are provided in the exemplary embodiment.

Sleeves 12, which are penetrated by clamping screws 5, may be provided on hold-down device 10 for correctly placing hold-down device 10 in relation to cylinder head 2, for spacing them, and for guiding clamping screws 5.

Hold-down device 10 also has recesses 13, whose number corresponds to the number of fuel injectors 1. Recesses 13 are designed in such a way that they form a formfitting connection together with shoulders 7 of fuel injectors 1. It may thus be ensured that the position of hold-down device 10 in relation to fuel injectors 1 and/or the position of fuel injectors 1 to one another may not change. In addition, the tightening torques of the screw connections formed by screw caps 14, for example, and the transverse forces of the fuel lines 15 fixed on fuel injectors 1 by the screw connections may thus be absorbed, compensated for, and transmitted. Recesses 13 may also be introduced into hold-down device 10 by stamping.

During the mounting of hold-down device 10, one spring element 11 per fuel injector 1 is inserted between the hold-down device and fuel injectors 1 and transmits the hold-down force to fuel injectors 1. Spring elements 11 are deformed elastically or also plastically-elastically in this process. Spring elements 11 may have a sleeve-shaped design having spring tongues 11a, which press against hold-down device 10. Spring tongues 11a may also be oriented in the direction of fuel injectors 1 and supported on shoulders 7 of fuel injectors 1.

Different arrangements of spring elements 11 both in regard to the shape and also the material used allow adaptation of the hold-down forces and of the possible tolerance compensation.

FIG. 3 shows an exemplary embodiment of a hold-down device 10 implemented according to the present invention in the same view as FIG. 2. Identical components are provided with corresponding reference numerals for the sake of clarity.

In contrast to the exemplary embodiment illustrated in FIG. 2, the exemplary embodiment illustrated in FIG. 3 of a hold-down device 10 has spring elements 11 formed in one piece therewith.

While in FIG. 2 spring elements 11 have a sleeve-shaped design having spring tongues 11a, which press against hold-down device 10 and allow absorption of the active forces by their elastic design, only spring clips 11b are provided in FIG. 3 and are advantageously formed in one piece with hold-down device 10 or are manufactured separately and are connected to hold-down device 10 in a suitable manner.

Hold-down device 10 also has a U-shape, but is oriented so that the opening of the U-shape is toward cylinder head 2 in the second exemplary embodiment. This makes sense because spring clips 11b are supported by and/or extend directly from curved legs 16 of U-shaped hold-down device 10.

The present invention is not restricted to the illustrated exemplary embodiments and is also usable, for example, for hold-down devices 10 for fuel injectors 1 for injecting fuel into the combustion chamber of an auto-ignition internal combustion engine.

1-17. (canceled)

18. An apparatus, comprising:
a hold-down device configured to elastically fasten multiple fuel injectors, held down in a cylinder head of an internal combustion engine by spring elements, for directly injecting fuel into a combustion chamber of an internal combustion engine;
wherein the hold-down device has a rail-shaped arrangement having recesses configured to receive the multiple fuel injectors.

19. The apparatus according to claim 18, wherein the recesses are configured to form a formfitting connection between the hold-down device and the multiple fuel injectors.

20. The apparatus according to claim 18, wherein the recesses are introduced into the hold-down device by stamping.

21. The apparatus according to claim 19, wherein the hold-down device has a U-shaped profile.

22. The apparatus according to claim 18, wherein the spring elements are formed between the fuel injectors and the hold-down device.

23. The apparatus according to claim 22, wherein the spring elements are clamped between the hold-down device and the fuel injectors at least one of (a) elastically and (b) plastically-elastically deformable.

24. The apparatus according to claim 22, wherein the spring elements include elastic spring tongues.

25. The apparatus according to claim 24, wherein the spring tongues of the spring elements abut on at least one of (a) the hold-down device and (b) on shoulders of the fuel injectors.

26. The apparatus according to claim 21, wherein an open side of the U-profile of the hold-down device faces away from a cylinder head.

27. The apparatus according to claim 18, wherein the spring elements are formed in one piece with the hold-down device.

28. The apparatus according to claim 18, wherein the spring elements are arranged as spring clips.

29. The apparatus according to claim 21, wherein the spring elements are arranged as spring clips that extend from legs of the U-shaped hold-down device.

30. The apparatus according to claim 21, wherein an open side of the U-profile of the hold-down device faces a cylinder head.

31. The apparatus according to claim 18, wherein the hold-down device is fixed on a cylinder head of the internal combustion engine by at least two clamping screws.

32. The apparatus according to claim 31, wherein the hold-down device has sleeves penetrated by the clamping screws.

33. The apparatus according to claim 18, wherein the fuel injectors are connected to fuel lines.

34. The apparatus according to claim 33, wherein the fuel lines, the fuel injectors, and the hold-down device are connected by screw caps.
